(19) United States
(12) Patent Application Publication
(10) Pub. No.: US 2024/0338398 A1
(43) Pub. Date: Oct. 10, 2024

(54) Efficient content extraction from unstructured dialog text

(71) Applicant: The Board of Trustees of the University of Illinois, Urbana, IL (US)

(72) Inventors: Yun Huang, Champaign, IL (US); Yiren Liu, Champaign, IL (US)

(21) Appl. No.: 18/627,097

(22) Filed: Apr. 4, 2024

Related U.S. Application Data
(60) Provisional application No. 63/457,292, filed on Apr. 5, 2023.

(51) Int. Cl. G06F 16/335; G06F 16/33; G06N 20/00

(52) U.S. Cl. CPC G06F 16/337; G06F 16/3344; G06N 20/00

(57) ABSTRACT

Systems and methods are provided to automate dialogs with community members providing reports of public safety events (e.g., crimes, medical emergencies, natural disasters) and to extract therefrom information to describe the particulars of such events across a wide range of possible event types. This includes using a first model to identify, from the community member's dialog text, a type for the incident being reported. This identification is then used to condition a second model to extract, from the community member's dialog text, one or more pieces of information relevant to the identified incident type (e.g., location of the incident, a description of a perpetrator of a crime, a description of a weapon used by the perpetrator, a description of a victim of the incident). The model can then output a subsequent response and/or a dialog tree or other expert system can select a pre-programmed response.

### CROSS-REFERENCE TO RELATED APPLICATION

The present application claims priority from U.S. provisional patent application No. 63/457,292, filed on Apr. 5, 2023, the contents of which are incorporated by reference.

### BACKGROUND

Available resources to receive safety-related reports (e.g., about crimes, about fires, about natural disasters, about health events) are limited. It can be beneficial to apply automated chat systems to relieve such resources by engaging in dialogs with community members and extracting incident report-relevant information therefrom, so that community members in need of assistance and/or involved in emergent situations can be serviced by human dispatchers, police, or other emergency services personnel. However, it is difficult to design or train automated systems to engage in such dialogs in a considerate manner while also obtaining all relevant information across a variety of different potential incident types. Such automated systems may also be tightly constrained with respect to available memory, processor capability, or other computational resources available to an emergency department.

### SUMMARY

In a first aspect, a method is provided that includes: (i) receiving initial text from a user; (ii) applying the initial text to a classifier to select, from an enumerated set of incident types, a session incident type, wherein the session incident type is associated with a set of session incident properties; (iii) applying the initial text and an indication of the set of session incident properties to a machine learning model to generate a value for a session incident property of the set of session incident properties; (iv) based on the session incident property, selecting, from a list of queries, a query about a further session incident property whose value has not yet been generated by the machine learning model in relation to the initial text; (v) providing the query to the user; (vi) receiving additional text from the user in response to the query; and (vii) applying the additional text and the indication of the set of session incident properties to the machine learning model to generate an additional value for an additional session incident property of the set of session incident properties.

In a second aspect, a method is provided that includes: (i) receiving initial text from a user; (ii) applying the initial text to a classifier to select, from an enumerated set of incident types, a session incident type, wherein the session incident type is associated with a set of session incident properties; (iii) applying the initial text and an indication of the set of session incident properties to a machine learning model to generate an output that indicates (a) a value for a session incident property of the set of session incident properties and (b) a query about a further session incident property of the set of session incident properties whose value has not yet been generated by the machine learning model in relation to the initial text; (iv) based on the output, updating a list indicating which of the set of session incident properties have values that have been generated by the machine learning model in relation to the initial text; (v) providing the query to the user; (vi) receiving additional text from the user in response to the query; and (vii) applying the additional text, the indication of the set of session incident properties, and an indication of the list to the machine learning model to generate an additional output that indicates an additional value for an additional session incident property of the set of session incident properties.

In a third aspect, a non-transitory computer readable medium is provided having stored thereon program instructions executable by at least one processor to cause the at least one processor to perform the method of the first or second aspects.

In a fourth aspect, system is provided that includes: (i) a controller comprising one or more processors, and (ii) a non-transitory computer readable medium having stored thereon program instructions executable by the controller to cause the controller to perform the method of the first or second aspects.

### BRIEF DESCRIPTION OF THE DRAWINGS

The accompanying drawings are included to provide a further understanding of the system and methods of the disclosure and are incorporated in and constitute a part of this specification. The drawings illustrate one or more embodiment(s) of the disclosure, and together with the description serve to explain the principles and operation of the disclosure.

FIG. 1 depicts aspects of an incident type classification model, in accordance with example embodiments.

FIG. 2 depicts aspects of an incident argument extraction model, in accordance with example embodiments.

FIG. 3 shows an example snippet from an annotated dialogue.

FIG. 4 depicts aspects of an example method.

FIG. 5 depicts aspects of an example system.

FIG. 6 depicts aspects of an example method.

FIG. 7 depicts aspects of an example method.

### DETAILED DESCRIPTION

The following detailed description describes various features and functions of the disclosed embodiments with reference to the accompanying figures. The illustrative embodiments described herein are not meant to be limiting. It may be readily understood that certain aspects of the disclosed embodiments can be arranged and combined in a wide variety of different configurations, all of which are contemplated herein.

To that end, example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false

### I. OVERVIEW

It is desirable in many scenarios to use automated agents to engage with users for routine tasks, thereby allowing human agents to engage with higher-priority users, e.g., users who are in need of immediate emergency assistance from emergency medical services, the fire department, the police, or other emergency services. For example, users who are contacting a health and safety department (e.g., the website of a police department) in order to report information about an incident that has already occurred could interact with an automated agent in order to provide information necessary to generate, in an automated or semi-automated fashion, a report that can then be used to investigate past incidents and/or predict or prepare for future incidents. Additionally, providing such systems, which can reduce the effort needed to provide a report (relative to, e.g., calling or going in person to a public safety office), can reduce under-reporting, particularly in the context of reporting crimes using emergency phone lines (911).

However, to achieve a specified level of accuracy and thoroughness with respect to the incident report such automated agents can obtain from human users, such automated agents can be computationally expensive to operate (e.g., with respect to the memory, computational cycles, or other computational resources needed to implement and execute such agents). When such agents include machine learning models or other elements trained using actual examples of user chat sessions or other user-based text, such agents can require significant amounts of such training data. These computational costs are amplified in the context of engaging with users providing reports on incidents as described herein, as such automated agents may also be required to exhibit emotional support to the users and to avoid interacting in a manner that is inconsiderate of the emotional state of users who may have recently experienced or witnessed criminal activity, injuries, or other emotionally significant incidents while also obtaining from such users an extensive set of information about such incidents.

Embodiments described herein provide automated agents that exhibit increased accuracy and thoroughness with respect to the ability to obtain, from users, relevant descriptive information about a variety of different types of incident (e.g., medical emergencies, crimes, natural disasters, events requiring community emergency services or investigation) while also exhibiting reduced computational cost (e.g., memory, processor cycles, amount of training data) relative to alternative systems and methods. These benefits are obtained by using the user's text inputs from an ongoing information reporting session (e.g., one or more chat messages sent by the user to a central server or other system via a website, chat application, or other communications channel) to first select, from an enumerated list of possible incident types, the type of incident the user is describing in the session.

This allows the identity of the selected incident type to be provided to downstream predictors (e.g., transformers, large language models (LLMs), or other machine learning models) thereby allowing them to condition on this information when extracting values for properties of the selected incident type. This can take the form of providing, to the downstream model(s), an incident type-specific list of properties whose values should be extracted from the user's already-provided text and/or whose values should be asked about by the agent. By allowing the downstream models to condition on the identified type of the incident, these downstream models can be smaller (and thus less computationally expensive to implement and execute) and can be trained and/or fine-tuned using a smaller amount of training data (relative to, e.g., models that must also ‘learn’ to identify the incident type and set of relevant properties therefor from the user text).

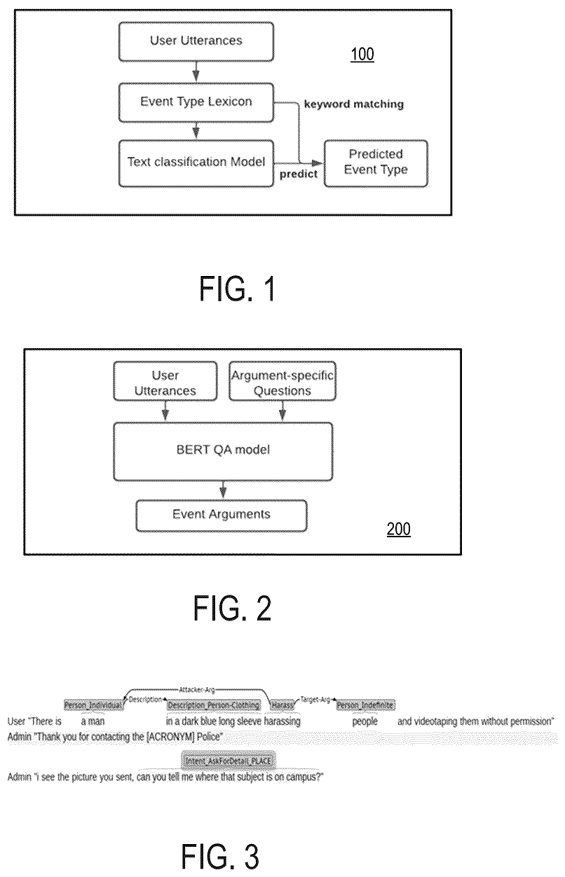

A variety of different classifiers can be used to select, from an enumerated list of possible incident types, an incident type for a current session based on user text received in the current session. For example, keyword matching methods, word, sentence, and/or paragraph vector embeddings, perceptrons or other types of neural networks operating on embeddings of the words in the user text, and/or other types of manually-programmed and/or trained methods could be applied. FIG. 1 depicts a particular example of aspects of such a classifier 100.

The classifier 100 first applies user text(s) (“User Utterances”) to a lexicon of keywords and/or key phrases (“Event Type Lexicon”), performing keyword matching between words and/or phrases of the user text and sets of keywords and/or hey phrases that correspond to the enumerated incident types. If a match is identified, the match is used to select one of the incident types (“Predicted Event Type”) from the enumerated list of possible incident types. If the keyword and/or key phrase matching does not identify a match (e.g., due to no matches being identified, or due to multiple incident types exhibiting sufficient matches to make it difficult or impossible to identify a single incident type from the set of types with matches), then the user text can be applied to a trained model (“Text classification Model”) to identify an incident type therefor. Such a trained model can be trained using, e.g., manually annotated sets of text or chat logs, and can include an artificial neural network, a logistic regression, and/or some other type of model architecture. By applying keyword matching first (which can exhibit significantly less computational cost than executing more complex models), and then applying a more complex model only when the keyword matching fails to identify an incident type, the expected computational cost of identifying an incident type for the user text can be reduced.

The enumerated list of possible incident types, and their associated sets of properties to be extracted from and/or evoked in user text, can be adapted to the particular application and intended location or population of use. For example, the enumerated list of possible incident types could include suspicious activity, drugs or alcohol, harassment or abuse, theft or lost item, mental health, and/or a generic “emergency message” about an incident that does not fall under any of the other incident types.

A variety of properties could be extracted from user text for some or all of the incident types. The properties could be related to the incident overall (“Event Arguments”) and/or to specific entities related to the incident. For example, “Event Arguments” for some or all of the incident types could include the identity of an attacker (or other instigating agent of the incident), the identity of a target of the incident (intentional or unintentional), the identity of a weapon used in the incident, a start time of the incident, an end time of the incident, a location of the incident, and/or a target object of the incident (in examples wherein two different properties are assigned, depending on whether the ‘target’ of the incident is an object or a person). Entities associated with an incident may be recorded as properties of the incident and/or may be used to organize properties of the incident such that, e.g., multiple “age” properties can be obtained for multiple different people involved in the incident, as targets, attackers, witnesses, or other entities associated with the incident. Entities could include persons, locations, weapons, times, and objects. Entities could be associated with sub-entities, e.g., descriptive properties like an age, race, appearance, clothing, sex, action taken, name, or movement engaged in by a person (e.g., by an attacker, target, or witness), a description of a location, and/or a phone number and/or email of a contact (e.g., of the user providing information).

In addition to predicting the type of incident being reported by a user, the embodiments herein include transmitting, to the user, queries or other text to cause the user to provide additional text such that all of the information relevant to a given type of incident is provided. This user-submitted text can then be applied to a machine learning model in order to extract values for all (or at least some) of the properties relevant to the identified incident type. By predicting the incident type separately from these processes, they can be performed using less computer resources and/or training data, since these processes can be performed in a manner than is conditioned on or otherwise performed in a manner dependent upon the identified session type.

In some examples, a trained machine learning model (e.g., based on transformers) can be used to predict, based on the set of text received from the user (and optionally the set of text previously presented to the user, e.g., query to evoke additional answers) values for one or more of the set of properties relevant to the identified incident type. A list of the set of properties that have been ‘answered’ by the user can then be updated to include the newly-predicted one or more of the set of properties. This list can then be used to select, from a dialog tree or other structured list of queries, a query about at least one of the set of session incident properties whose value has not yet been generated by the machine learning model. This process can then be repeated until values have been predicted for all, or more than a threshold number, of the set of properties relevant to the identified incident type.

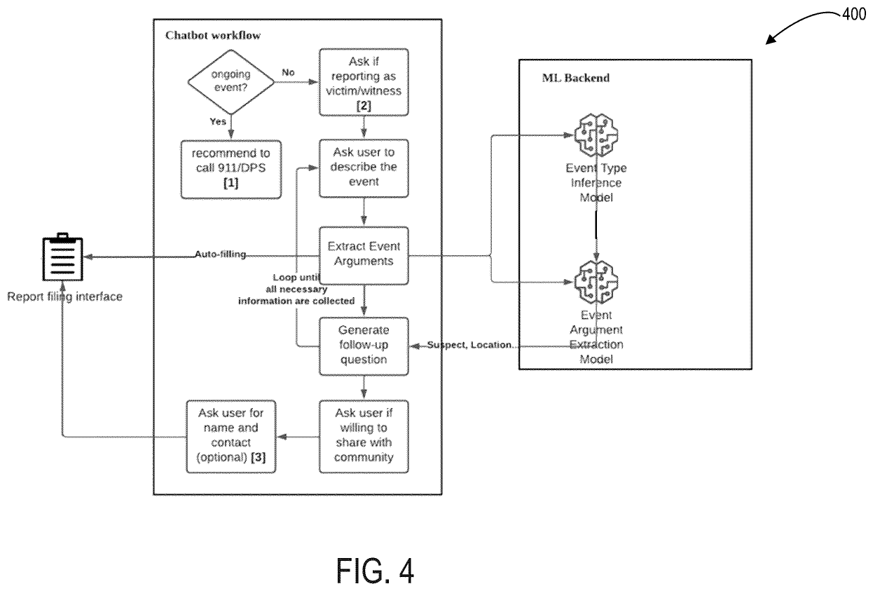

FIG. 4 illustrates aspects of an example of such a process 400. A user responds to a query (“Ask user to describe the event”) with text, and that text is applied to a classifier (“Event Type Inference Model,” e.g., the classifier 100 of FIG. 1) to identify, from an enumerated list of possible incident types, the type of incident that the user is reporting in the current chat session. This may be referred to as the “session incident type.” The user text, along with an indication of the session incident type, are provided to a machine learning model (“Event Argument Extraction Model”) in order to determine therefrom values for one or more of the pre-specified set of properties that are relevant to the session incident type. The set of properties whose values have been extracted in this manner is then used to generate a query (“Generate follow-up question,” e.g., using a dialog tree or other list of queries). This can result in the follow-up query about other(s) of the set of properties being indicated to the user to prompt an answer. Alternatively, if it is determined that values for all, or more than a threshold number of, the session incident type-relevant properties have been extracted, the chat session could be terminated. Such termination could optionally include asking for additional information, e.g., contact information for the user and/or consent to share some or all of the reported information with the community publicly, with specified governmental or non-governmental agencies, or with some other group or individual(s).

Indeed, FIG. 4 depicts a number of optional additional steps or processes that may or may not be used in combination with the incident type identification and property value extraction methods described herein. For example, FIG. 4 depicts some optional initial steps for a chat session. These optional initial steps include verifying that the user is not presently experiencing an ongoing emergency incident (“ongoing event?”), and if they are, directing them to contact emergency services, and asking the user whether they are reporting an incident that they themselves were a part of as a victim or witness (“Ask if reporting as victim/witness”) or if they are, instead, reporting on behalf of someone else. A chat session as described herein can also include providing an initial default query to the user to prompt them to begin providing information about the incident (at “Ask user to describe the event”) which, in subsequent exchanges of the chat session, would be substituted by queries selected by a dialog tree or via some other method (e.g., using an LLM or other generative model to generate follow-up queries).

A model configured to extract values for incident type-relevant properties from user text as described herein (e.g., an “Event Argument Extraction Model), and the set of arguments applied thereto to generate such outputs, could take a variety of forms. For example, FIG. 2 depicts aspects of such a machine learning model 200 that receives as inputs user text (“User Utterances”) and an indication of the identified session incident type (in the form of a set of “Argument-specific queries” for each of the properties in the set of session incident type-relevant properties). These are applied to a trained transformer-based model (e.g., a “BERT QA model” that has been trained to operate as a query-answering model) to generate an output (“Event Arguments”) that represents values for one or more of the incident-type specific properties represented in the model input.

As noted above, indicating the identified session incident type can include providing, as part of a textual input to the model 200, queries corresponding to each of the properties that are relevant to the identified incident type. Additionally or alternatively, names or descriptions of the set of properties could be provided. In some examples, an indication of the set of the properties for which values have already been determined by the model 200 could also be provided; alternatively, the queries for properties whose values have already been determined could be omitted from the list of queries applied as input to the model 200. The user text applied as input to the model 200 could include all of the user text received from the user in the current chat session, or could be limited to the most recent user response or other user input.

Such a value-extracting model could be trained in a variety of ways based on a variety of chat logs or other training data. In some examples, the model (e.g., 200) could be trained on chat logs that have been annotated to indicate the property values (or “arguments”) to be extracted therefrom and/or with the incident type of the chat sessions therein. Such annotations can also include annotations indicating the intent of the user and/or other entities (e.g., a dispatcher) in the set of chat logs; such annotations could be used to train a model to estimate user sentiment or emotional state, to generate follow-up queries, or to perform some other task(s). FIG. 3 indicates some examples of chat log text that has been annotated in order to facilitate supervised model training. As shown in FIG. 3, both user text (“User”) and dispatcher text (“Admin”) in the chat logs can be annotated with intents (“Intent_AskForDetail_PLACE”), text indicative of incident type (“Harass”), and text indicative of values for the properties relevant to the incident type of the chat text (“Person_Indefinite,” “Attacker-Arg,” “Description”).

Additionally or alternatively, a trained machine learning model (e.g., an LLM) can be used to predict, based on the set of text received from the user (and optionally the set of text previously presented to the user, e.g., to guide additional answers), (i) values for one or more of the set of properties relevant to the identified incident type and (ii) a query about one or more of the set of properties relevant to the identified incident type whose values have not yet been predicted by the machine learning model. The output query can then be indicated to a user in order evoke further text indicative of further properties relevant to the identified incident type.

Executing such a model could include applying as input to the model both the already-received user text and an indication of identified session incident type. Such an indication can include indicating a list of the set of properties relevant to the identified incident type (e.g., as a set of queries, one for each of the relevant properties). A model used in this way can achieve a desired level of accuracy while being smaller (or otherwise less computationally expensive to implement or execute) and/or can be trained using less training data, since the model will not also need to ‘learn’ how to predict the type of the incident or the set of properties that are relevant to each of the enumerated types of incidents. Input to such a model can also include the set of queries or other text provided to the user to evoke their textual responses, an indication of the values of properties whose values have already been determine by the model, or other inputs.

The set of session incident type-relevant properties for which values have been determined could be tracked and used to, e.g., determine whether to terminate the session. For example, if it is determined that values for all, or for more than a threshold number of, the session incident type-relevant properties have been generated by the model, the chat session could be terminated. This allows the model, for a given level of accuracy, to be less computationally expensive to execute and/or to require less training data to train, since the model does not also need to predict whether to terminate the chat.

Such a query-generating model could be created in a variety of ways. For example, a pre-trained model (e.g., a generic query-answering model that has been trained on a large corpus of query-answer pairs) could be obtained and fine-tuned to predict a ‘next query’ that evokes information about non-answered input queries in addition to predicting the answers to those input queries whose values can be predicted based on the available user responses. Each chat log could provide a number of different training examples, as the model could be trained to predict each dispatcher response in a chat log based on the respective set of preceding user and dispatcher responses.

Models to predict incident type, to extract values for incident type-relevant properties, and to predict follow-up queries to evoke information about non-extracted incident properties as described herein can be trained using available chat log training data. A dataset of real-world user-dispatcher dialogues from the domain of safety incident reporting can be used for this training data. The dialogues can be collected using the LiveSafe app (other another application), which allows users to report certain incidents to a human agent via a chat service. LiveSafe is a community-based risk management system that focuses on increasing involvement and communication between members of an organization and the safety teams responsible for mitigating broad-spectrum risk. Community members submit information (“tips”) through the LiveSafe mobile app or web portal, while safety organization managers respond to tips through the LiveSafe Command Dashboard. After the user's submission, the dispatchers from safety departments can reply to each tip and start a conversation with the user through the Command Dashboard provided by LiveSafe.

The initial dataset may contain a large amount of “noise,” for example niche or organizational-specific tip categories. The data can be cleaned by removing “Test” tips and automatically created “Calls” entries (where users call the admins via the app) and also by removing tips that were submitted within the first year of implementation for each organization to ensure the organization had formed a consistent report handling workflow. The dataset can be also filtered by removing chats with fewer than three utterances (a single conversation turn), limiting the training dataset to chats with at least one turn of information-collecting conversation.

After performing this data cleaning, the resulting dialogues can be categorized into different incident categories, which individuals selected before initiating a chat conversation. Sensitive information (names, places, times, etc) in the dataset was masked for privacy. Note that this this masking may have an effect on model performance, since it is not always clear what the masked value was (e.g. “The incident must have occurred sometime between [TIME] and [TIME] which is when I got out of work.”).

To capture the incident information from the conversations between users and dispatchers, an “incident ontology” (or, alternatively, “event ontology”) was created to organize community incident extraction into different incident types and sub-types and related properties thereof. The final ontology may include three parts: incident type, incident argument, and (optionally) dispatcher intent. Since the initial incident category information provided by the LiveSafe dataset is coarse-grained and incident tips within the same category could turn out to be completely different incidents (e.g. domestic abuse and random harassment under HarrassmentAbuse), more fine-grained incident type information was annotated to distinguish such incidents. The incident types from this finer-grained ontology include Attack, Harassment, Abuse, Threat, Robbery, Theft, and Break-in. Incident types Attack, Harassment, Abuse, and Threat belong specifically to category HarassmentAbuse, and Robbery, Theft, and Break-in to TheftLostItem. During annotation of each incident, a word or phase can be selected as the incident type and annotated as such. For the annotation of incident arguments, the Automatic Content Extraction (ACE) dataset schema can be modified to increase resolution and applied to analyze LiveSafe chat logs.

The incident arguments that are annotated include Attacker, Target, Location, Weapon, Start Time, End Time, and Target Object. Each incident argument can be connected to the incident handle, as a part of the incident information. Dispatchers' intent when asking users queries to collect additional event-related information can also be annotated. This includes noting which event argument dispatchers were asking for more information about. For example, as in FIG. 3, the dispatcher asked “where that subject is on campus”, which was annotated as asking for detail about Location information.

After the final ontology was defined, two researchers annotated a total of 69 event chat logs with the ontology. The result annotations were considered consistent given an inter-annotator agreement (Cohen's Kappa) of 0.87. An example of annotated dialogue is shown in FIG. 3. The resulting annotated dataset contained a total of 69 conversations and 972 utterances.

Users reporting an incident might be subject to different causes that could lead to emotional instability or duress. Users who are experiencing or have experienced difficult or traumatizing safety incidents will often exhibit “emotional pain.” In practice, human dispatchers may react to the emotional display of users to increase the users' trust in dispatchers and willingness to cooperate. This can include using directives, reassurances, realignment, repetitive persistence, and redirection of attention.

A model as described herein that predicts follow-up queries to evoke information about non-extracted incident properties could also be trained to provide responses that exhibit more compassion, especially for users exhibiting heightened emotional states. This can be done in order to provide additional comfort to such users, to respect their experiences, and to make it easier and less emotionally taxing for them to provide information about incidents that they are reporting. In some examples, such models could be trained to receive an additional input that is indicative of an emotional state of the user and to condition generated query outputs on that state input. This can be done in order to allow the model to have a reduced computational cost, since the model would not need to also be able to predict the emotional state internally.

The emotional state input could be generated, based on prior user text, using a sentiment prediction model (such as an LLM) or some other method for predicting a user's emotional state based on textual inputs therefrom. The predicted emotional state could take the form of a numerical value (e.g., a number 1-10 indicating a degree of emotional stress or duress experienced by the user) and/or a categorical description of the user's emotional state (e.g., anger, fear, joy, sadness, surprise and love). Training datasets including such emotional state information could be generated by applying a sentiment prediction model or some other method for predicting a user's emotional state to existing chat logs in order to provide annotations of the chat logs that represent the user's predicted emotional state over time, based on the text inputs provided by the user over time within each chat session of the chat logs.

Such training datasets can also be augmented in order to increase the amount of emotional support represented in the training datasets. This can result in models trained thereon exhibiting greater emotional care for users. This augmentation can include applying available chat logs to an LLM or other generative machine learning language model with a prompt to “increase the emotional support” of the input.

Where an LLM or other large, computationally expensive model is used to perform the methods described herein (e.g., to extract values for session incident type-relevant properties, to generate follow-up queries), such models can be executed remotely from a server or other computational system that performs the remainder of the method. For example, a server or other computational system located in a fire station or other community support office could operate to facilitate users' beginning chat sessions with the system, directing such users to 911 in the event that they are reporting emergent incidents, executing a classifier on users' text to identify incident types therefor, determining sets of relevant properties for identified incident types, and updating lists of values for such sets of properties as those values are extracted from user text. However, execution of an argument-extraction and/or query-generation model or other model as described herein could include the server or other computational system transmitting relevant information (e.g., user text, a list of session incident type-relevant properties, queries asking about each of the list of session incident type-relevant properties) to a remote computational system (e.g., a cloud computing system) that then executes the model based on the transmitted information. The remote computational system could then transmit the output of the model to the server or other computational system, which can then perform other aspects of the methods described herein based on that output. Such a setup can allow organizations or systems with relatively constrained computational resources (e.g., a single serve with limited memory, storage, or processor bandwidth) to accomplish the methods described herein by relying for only model execution on a remote system or service, which may be adapted to perform large model execution and/or which can provide such model execution services to many clients, increasing operational efficiency and utilization of such a service.

As described herein, an LLM is an advanced computational model, primarily functioning within the domain of natural language processing (NLP) and machine learning. An LLM can be configured to understand, interpret, generate, and respond to human language in a manner that is both contextually relevant and syntactically coherent. The underlying structure of an LLM is typically based on a neural network architecture, more specifically, a variant of the transformer model. Transformers are notable for their ability to process sequential data, such as text, with high efficiency.

The operation of an LLM involves layers of interconnected processing units, known as neurons, which collectively form a deep neural network. This network can be trained on vast datasets comprising text from diverse sources, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM's output and expected output.

An aspect of an LLM's functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model's ability to generate contextually relevant and coherent text by understanding the relationships and dependencies between words or tokens in a sentence (or longer parts of texts), regardless of their position.

Upon receiving an input, such as a text query or a prompt, the LLM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LLM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

Some LLMs are multimodal in that they can receive prompts in formats other than text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and produce images and/or audio.

### II. EXAMPLE SYSTEMS

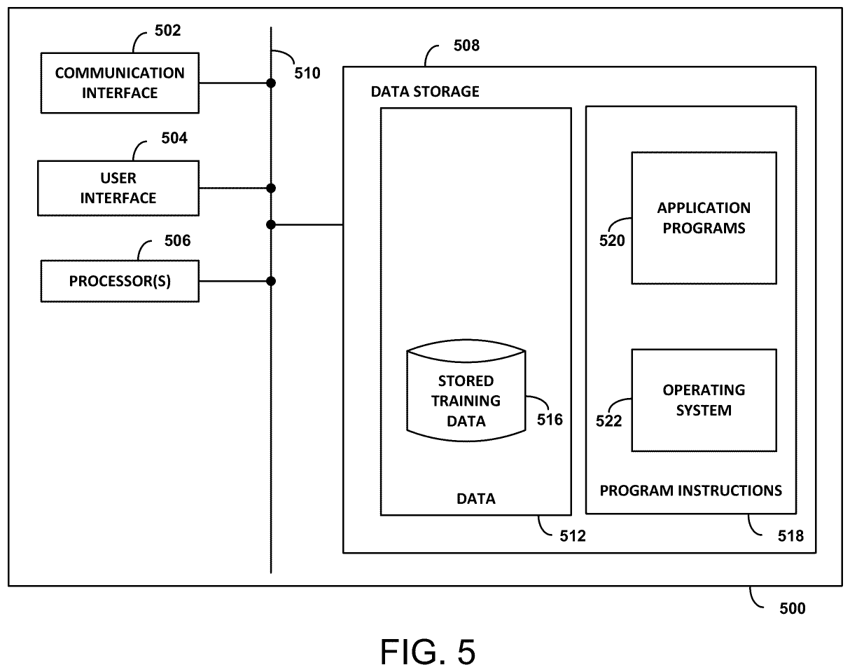

FIG. 5 illustrates an example system 500 that may be used to implement the methods and/or apparatus described herein. By way of example and without limitation, system 500 may be or include a computer (such as a desktop, notebook, tablet, or handheld computer, a server), a cloud computing system or service, or some other type of device or system or combination of devices and/or systems. It should be understood that elements of system 500 may represent a physical instrument and/or computing device such as a server, a particular physical hardware platform on which applications operate in software, or other combinations of hardware and software that are configured to carry out functions as described herein.

As shown in FIG. 5, system 500 may include a communication interface 502, a user interface 504, one or more processors 506, and data storage 508, all of which may be communicatively linked together by a system bus, network, or other connection mechanism 510.

Communication interface 502 may function to allow system 500 to communicate, using analog or digital modulation of electric, magnetic, electromagnetic, optical, or other signals, with other devices (e.g., with systems providing a user interface via which text or other information can be provided to and/or received from individuals providing information about incidents that have occurred), access networks, and/or transport networks. Thus, communication interface 502 may facilitate circuit-switched and/or packet-switched communication, such as plain old telephone service (POTS) communication and/or Internet protocol (IP) or other packetized communication. For instance, communication interface 502 may include a chipset and antenna arranged for wireless communication with a radio access network or an access point. Also, communication interface 502 may take the form of or include a wireline interface, such as an Ethernet, Universal Serial Bus (USB), or High-Definition Multimedia Interface (HDMI) port. Communication interface 502 may also take the form of or include a wireless interface, such as a WiFi, BLUETOOTH®, global positioning system (GPS), or wide-area wireless interface (e.g., WiMAX, 3GPP Long-Term Evolution (LTE), or 3GPP 5G). However, other forms of physical layer interfaces and other types of standard or proprietary communication protocols may be used over communication interface 502. Furthermore, communication interface 502 may comprise multiple physical communication interfaces (e.g., a WiFi interface, a BLUETOOTH® interface, and a wide-area wireless interface).

User interface 504 may function to allow system 500 to interact with a user, for example to receive input from and/or to provide output to the user. Thus, user interface 504 may include input components such as a keypad, keyboard, touch-sensitive or presence-sensitive panel, computer mouse, trackball, joystick, microphone, and so on. User interface 504 may also include one or more output components such as a display screen which, for example, may be combined with a presence-sensitive panel. The display screen may be based on CRT, LCD, and/or LED technologies, or other technologies now known or later developed. User interface 504 may also be configured to generate audible output(s), via a speaker, speaker jack, audio output port, audio output device, earphones, and/or other similar devices.

Processor(s) 506 may comprise one or more general purpose processors—e.g., microprocessors—and/or one or more special purpose processors—e.g., digital signal processors (DSPs), graphics processing units (GPUs), floating point units (FPUs), network processors, tensor processing units (TPUs), or application-specific integrated circuits (ASICs). Data storage 508 may include one or more volatile and/or non-volatile storage components, such as magnetic, optical, flash, or organic storage, and may be integrated in whole or in part with processor(s) 506 and/or with some other element of the system. Data storage 508 may include removable and/or non-removable components.

Processor(s) 506 may be capable of executing program instructions 518 (e.g., compiled or non-compiled program logic and/or machine code) stored in data storage 508 to carry out the various functions described herein. Therefore, data storage 508 may include a non-transitory computer-readable medium, having stored thereon program instructions that, upon execution by system 500, cause system 500 to carry out any of the methods, processes, or functions disclosed in this specification and/or the accompanying drawings. The execution of program instructions 518 by processor(s) 506 may result in processor 506 using data 512.

By way of example, program instructions 518 may include an operating system 522 (e.g., an operating system kernel, device driver(s), and/or other modules) and one or more application programs 520 (e.g., functions for executing the methods described herein) installed on system 500. Data 512 may include stored training data 516 (e.g., stored chat logs) that can be used to train and/or update one or more models used as part of any of the methods described herein.

Application programs 520 may communicate with operating system 522 through one or more application programming interfaces (APIs). These APIs may facilitate, for instance, application programs 520 transmitting or receiving information via communication interface 502, receiving and/or displaying information on user interface 504, and so on.

Application programs 520 may take the form of “apps” that could be downloadable to system 500 through one or more online application stores or application markets (via, e.g., the communication interface 502). However, application programs can also be installed on system 500 in other ways, such as via a web browser or through a physical interface (e.g., a USB port) of the system 500.

### III. EXAMPLE METHODS

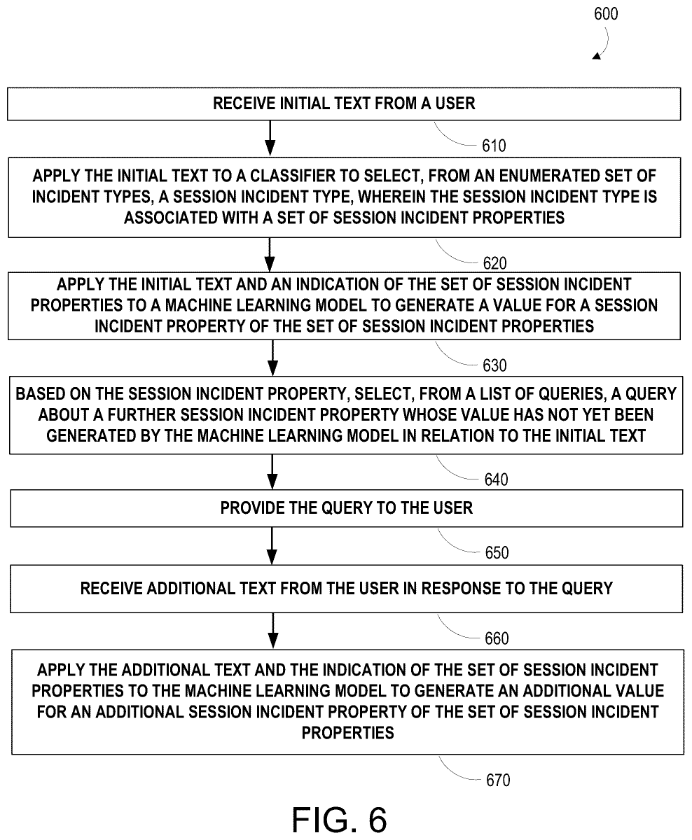

FIG. 6 depicts an example method 600. The method 600 includes receiving initial text from a user (610). This can include: (i) indicating, to the user, a query about whether an incident is ongoing; (ii) responsively receiving, from the user, a response indicating that the incident is not ongoing; and (iii) responsive to receiving the response indicating that the incident is not ongoing, indicating, to the user, a prompt to describe the incident, wherein the initial text is received from the user in response to the prompt to describe the incident.

The method additionally includes applying the initial text to a classifier to select, from an enumerated set of incident types, a session incident type, wherein the session incident type is associated with a set of session incident properties (620). This could include (i) performing keyword matching between words of the initial text and sets of one or more keywords for each incident type in the enumerated set of incident types to determining that the initial text does not match any of the sets of one or more keywords for any of the enumerated set of incident types; and (ii) responsive to determining that the initial text does not match any of the sets of one or more keywords, applying the initial text to a machine learning text classification model to select, from an enumerated set of incident types, the session incident type. The enumerated set of incident types include suspicious activity, drugs or alcohol, harassment or abuse, theft or lost item, and mental health.

The method additionally includes applying the initial text and an indication of the set of session incident properties to a machine learning model to generate a value for a session incident property of the set of session incident properties (630). The machine learning model can be trained using chat logs that have been annotated to indicate portions of the chat logs that indicate values of incident properties and identities of the incident properties. The machine learning model can include a transformer.

The method additionally includes based on the session incident property, selecting, from a list of queries, a query about a further session incident property whose value has not yet been generated by the machine learning model in relation to the initial text (640).

The method additionally includes providing the query to the user (650).

The method additionally includes receiving additional text from the user in response to the query (660).

The method additionally includes applying the additional text and the indication of the set of session incident properties to the machine learning model to generate an additional value for an additional session incident property of the set of session incident properties (670).

The method 600 could include additional steps or features. For example, the method 600 could include, subsequent to applying the additional text and the indication of the set of session incident properties to the machine learning model, determining that values have been generated by the machine learning model in relation to text from the user for at least a threshold number of the set of session incident properties and responsively terminating a chat session with the user.

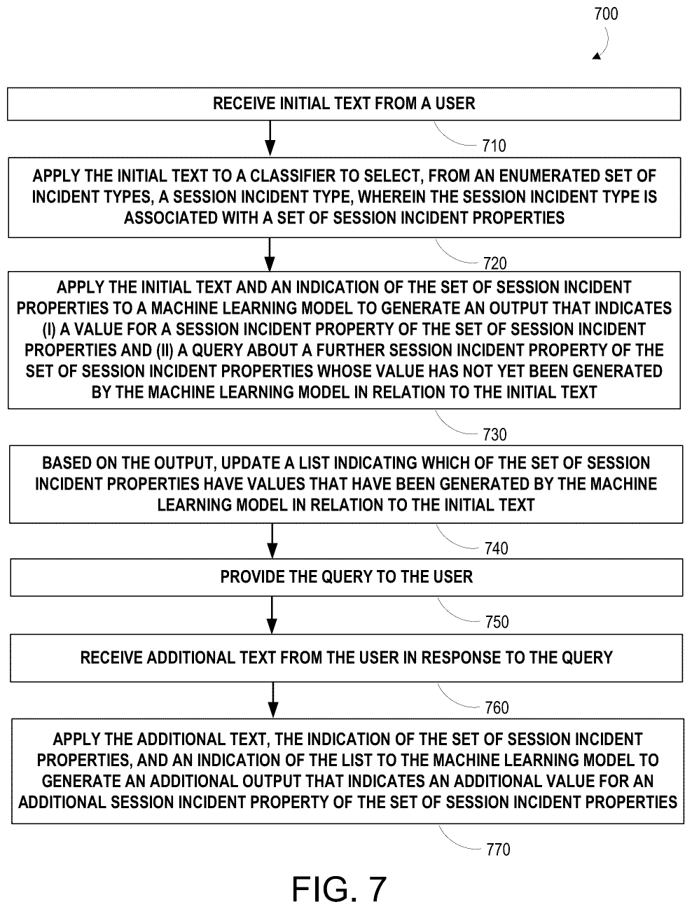

FIG. 7 depicts an example method 700. The method 700 includes receiving initial text from a user (710). This can include: (i) indicating, to the user, a query about whether an incident is ongoing; (ii) responsively receiving, from the user, a response indicating that the incident is not ongoing; and (iii) responsive to receiving the response indicating that the incident is not ongoing, indicating, to the user, a prompt to describe the incident, wherein the initial text is received from the user in response to the prompt to describe the incident.

The method 700 additionally includes applying the initial text to a classifier to select, from an enumerated set of incident types, a session incident type, wherein the session incident type is associated with a set of session incident properties (720). This could include (i) performing keyword matching between words of the initial text and sets of one or more keywords for each incident type in the enumerated set of incident types to determining that the initial text does not match any of the sets of one or more keywords for any of the enumerated set of incident types; and (ii) responsive to determining that the initial text does not match any of the sets of one or more keywords, applying the initial text to a machine learning text classification model to select, from an enumerated set of incident types, the session incident type. The enumerated set of incident types include suspicious activity, drugs or alcohol, harassment or abuse, theft or lost item, and mental health. The enumerated set of incident types include suspicious activity, drugs or alcohol, harassment or abuse, theft or lost item, and mental health.

The method 700 additionally includes applying the initial text and an indication of the set of session incident properties to a machine learning model to generate an output that indicates (i) a value for a session incident property of the set of session incident properties and (ii) a query about a further session incident property of the set of session incident properties whose value has not yet been generated by the machine learning model in relation to the initial text (730). The machine learning model can have been trained using chat logs that have been annotated to indicate portions of the chat logs that indicate values of incident properties and identities of the incident properties. Additionally or alternatively, the machine learning model can have been trained using non-annotated chat logs to predict dispatcher responses to user text based on sets of prior user text and dispatcher queries. Additionally or alternatively, the machine learning model can have been trained using chat logs that have been augmented by applying the chat logs to a generative machine learning language model to generate therefrom simulated chat logs that exhibit increased emotional support. The machine learning model can include a large language model.

The method 700 additionally includes, based on the output, updating a list indicating which of the set of session incident properties have values that have been generated by the machine learning model in relation to the initial text (740).

The method 700 additionally includes providing the query to the user (750).

The method 700 additionally includes receiving additional text from the user in response to the query (760).

The method 700 additionally includes applying the additional text, the indication of the set of session incident properties, and an indication of the list to the machine learning model to generate an additional output that indicates an additional value for an additional session incident property of the set of session incident properties (770).

The method 700 could include additional steps or features. For example, the method 700 could include, subsequent to applying the additional text, the indication of the set of session incident properties, and the representation of the list to the machine learning model, determining that values have been generated by the machine learning model in relation to text from the user for at least a threshold number of the set of session incident properties and responsively terminating a chat session with the user. In another example, the method 700 could include determining, based on the initial text and the additional text, a user emotional state, wherein applying the additional text, the indication of the set of session incident properties, and the representation of the list to the machine learning model to generate the additional output comprises applying the additional text, the indication of the set of session incident properties, the representation of the list to the machine learning model, and an indication of the user emotional state to generate the additional output. Determining the user emotional state based on the initial text and the additional text could include applying the initial text and the additional text to a sentiment prediction model. In such examples, the machine learning model could have been trained using chat logs that have been augmented by applying the sentiment prediction model thereto to annotate user text in the chat logs with user emotional state information predicted from the user text.

In some examples, receiving the initial text (710), applying the initial text to a classifier (720), providing the query to the user (750), and receiving the additional text (760) are performed by a first computational system; in such examples, applying the initial text and the indication of the set of session incident properties to the machine learning model can include: (i) transmitting, from the first computational system to a second computational system that is remote from the first computational system, an indication of the initial text and the set of session incident properties; (ii) applying, by the second computational system, the initial text and the indication of the set of session incident properties to the machine learning model to generate the output; and (iii) transmitting, from the second computational system to the first computational system, an indication of the output.

It should be understood that arrangements described herein are for purposes of example only. As such, those skilled in the art will appreciate that other arrangements and other elements (e.g. machines, interfaces, operations, orders, and groupings of operations, etc.) can be used instead of or in addition to the illustrated elements or arrangements.

### V. CONCLUSION

It should be understood that arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. It is also to be understood that the terminology used herein is for the purpose of describing particular implementations only, and is not intended to be limiting.

We claim:

1. A method comprising:
receiving initial text from a user;
applying the initial text to a classifier to select, from an enumerated set of incident types, a session incident type, wherein the session incident type is associated with a set of session incident properties;
applying the initial text and an indication of the set of session incident properties to a machine learning model to generate a value for a session incident property of the set of session incident properties;
based on the session incident property, selecting, from a list of queries, a query about a further session incident property whose value has not yet been generated by the machine learning model in relation to the initial text;
providing the query to the user;
receiving additional text from the user in response to the query; and
applying the additional text and the indication of the set of session incident properties to the machine learning model to generate an additional value for an additional session incident property of the set of session incident properties.

2. The method of claim 1, wherein applying the initial text to the classifier comprises:
performing keyword matching between words of the initial text and sets of one or more keywords for each incident type in the enumerated set of incident types to determining that the initial text does not match any of the sets of one or more keywords for any of the enumerated set of incident types; and
responsive to determining that the initial text does not match any of the sets of one or more keywords, applying the initial text to a machine learning text classification model to select, from an enumerated set of incident types, the session incident type.

3. The method of claim 1, wherein enumerated set of incident types include suspicious activity, drugs or alcohol, harassment or abuse, theft or lost item, and mental health.

4. The method of claim 1, further comprising:
subsequent to applying the additional text and the indication of the set of session incident properties to the machine learning model, determining that values have been generated by the machine learning model in relation to text from the user for at least a threshold number of the set of session incident properties and responsively terminating a chat session with the user.

5. The method of claim 1, wherein the machine learning model has been trained using chat logs that have been annotated to indicate portions of the chat logs that indicate values of incident properties and identities of the incident properties.

6. The method of claim 1, wherein receiving initial text from a user comprises:
indicating, to the user, a query about whether an incident is ongoing;
responsively receiving, from the user, a response indicating that the incident is not ongoing; and
responsive to receiving the response indicating that the incident is not ongoing, indicating, to the user, a prompt to describe the incident, wherein the initial text is received from the user in response to the prompt to describe the incident.

7. The method of claim 1, wherein the machine learning model comprises a transformer.

8. A method comprising:
receiving initial text from a user;
applying the initial text to a classifier to select, from an enumerated set of incident types, a session incident type, wherein the session incident type is associated with a set of session incident properties;
applying the initial text and an indication of the set of session incident properties to a machine learning model to generate an output that indicates (i) a value for a session incident property of the set of session incident properties and (ii) a query about a further session incident property of the set of session incident properties whose value has not yet been generated by the machine learning model in relation to the initial text;
based on the output, updating a list indicating which of the set of session incident properties have values that have been generated by the machine learning model in relation to the initial text;
providing the query to the user;
receiving additional text from the user in response to the query; and
applying the additional text, the indication of the set of session incident properties, and an representation of the list to the machine learning model to generate an additional output that indicates an additional value for an additional session incident property of the set of session incident properties.

9. The method of claim 8, wherein applying the initial text to the classifier comprises:
performing keyword matching between words of the initial text and sets of one or more keywords for each incident type in the enumerated set of incident types to determining that the initial text does not match any of the sets of one or more keywords for any of the enumerated set of incident types; and
responsive to determining that the initial text does not match any of the sets of one or more keywords, applying the initial text to a machine learning text classification model to select, from an enumerated set of incident types, the session incident type.

10. The method of claim 8, wherein enumerated set of incident types include suspicious activity, drugs or alcohol, harassment or abuse, theft or lost item, and mental health.

11. The method of claim 8, further comprising:
subsequent to applying the additional text, the indication of the set of session incident properties, and the representation of the list to the machine learning model, determining that values have been generated by the machine learning model in relation to text from the user for at least a threshold number of the set of session incident properties and responsively terminating a chat session with the user.

12. The method of claim 8, wherein the machine learning model has been trained using chat logs that have been annotated to indicate portions of the chat logs that indicate values of incident properties and identities of the incident properties.

13. The method of claim 8, wherein the machine learning model has been trained using non-annotated chat logs to predict dispatcher responses to user text based on sets of prior user text and dispatcher queries.

14. The method of claim 8, wherein receiving initial text from a user comprises:
indicating, to the user, a query about whether an incident is ongoing;
responsively receiving, from the user, a response indicating that the incident is not ongoing; and
responsive to receiving the response indicating that the incident is not ongoing, indicating, to the user, a prompt to describe the incident, wherein the initial text is received from the user in response to the prompt to describe the incident.

15. The method of claim 8, further comprising:
determining, based on the initial text and the additional text, a user emotional state, wherein applying the additional text, the indication of the set of session incident properties, and the representation of the list to the machine learning model to generate the additional output comprises applying the additional text, the indication of the set of session incident properties, the representation of the list to the machine learning model, and an indication of the user emotional state to generate the additional output.

16. The method of claim 15, wherein determining the user emotional state based on the initial text and the additional text comprises applying the initial text and the additional text to a sentiment prediction model.

17. The method of claim 16, wherein the machine learning model has been trained using chat logs that have been augmented by applying the sentiment prediction model thereto to annotate user text in the chat logs with user emotional state information predicted from the user text.

18. The method of claim 8, wherein the machine learning model has been trained using chat logs that have been augmented by applying the chat logs to a generative machine learning language model to generate therefrom simulated chat logs that exhibit increased emotional support.

19. The method of claim 8, wherein receiving the initial text, applying the initial text to a classifier, providing the query to the user, and receiving the additional text are performed by a first computational system, and wherein applying the initial text and the indication of the set of session incident properties to the machine learning model comprises:
transmitting, from the first computational system to a second computational system that is remote from the first computational system, an indication of the initial text and the set of session incident properties;
applying, by the second computational system, the initial text and the indication of the set of session incident properties to the machine learning model to generate the output; and
transmitting, from the second computational system to the first computational system, an indication of the output.

20. The method of claim 8, wherein the machine learning model comprises a large language model.
